(19) United States
(12) Patent Application Publication
(10) Pub. No.: US 2013/0268595 A1
(43) Pub. Date: Oct. 10, 2013

(54) DETECTING COMMUNITIES IN TELECOMMUNICATION NETWORKS

(71) Applicants: Saravanan MOHAN, Chennai (IN); Jayakumar Alagappan Meenakshi, Mandurai (IN)

(72) Inventors: Saravanan MOHAN, Chennai (IN); Jayakumar Alagappan Meenakshi, Mandurai (IN)

(73) Assignee: Telefonaktiebolaget L M Ericsson (publ)

(21) Appl. No.: 13/606,393

(22) Filed: Sep. 7, 2012

(30) Foreign Application Priority Data
Apr. 6, 2012 (IN) 1064/DEL/2012

(51) Int. Cl. H04L 12/58

(52) U.S. Cl. CPC H04L 51/32
USPC 709/204

(57) ABSTRACT

Methods of identifying user communities in a telecommunication network include extracting fields from communication records that contain data regarding communications of users of the telecommunication network, generating a plurality of nodes corresponding to users of the telecommunication network based on the extracted fields, determining similarities between pairs of nodes using a similarity metric that measures relationships between the users of the telecommunication network, and grouping the plurality of nodes into non-overlapping communities based on the determined similarities. Related systems and computer program products are also disclosed.

### CLAIM OF PRIORITY

This application claims priority under 35 U.S.C. §119 from Indian Patent Application No. 1064/DEL/2012, filed on Apr. 6, 2012, the disclosure of which is hereby incorporated by reference herein as if set forth in its entirety.

### TECHNICAL FIELD

The present disclosure relates to communication networks, and in particular systems, methods and computer program products for detecting communities of users of a communication network.

### BACKGROUND

With the increase in various social networks, including telecommunication networks, social media, office networks, academic networks, community networks etc., the use of social computing is also increasing. Social computing provides support for generating personalized recommendations for users by exploring social behavior of a group of users through computational methods. Using information exploration theory, interesting items are identified for users based on their profiles and recent activities. In a telecommunication network, recommendations related to special plans or non-core offers, available at little or at no cost, may be provided to users. Group recommendations may be generated based an integrated group profile or the integration of recommendations built for each member of the group separately.

The combination of the social networks with graph mining techniques has opened vast opportunities for social computing. For example, a telecom network can be graphically represented as a structure made of nodes that represent users in the network. A graph may be used to model pair-wise relations between the nodes of the network. For example, edges between nodes may be drawn to represent interactions between the nodes. Communities are sub-graphs of the nodes in a network. In particular, a community may be defined as a group of nodes that are more closely connected with each other than they are with other network nodes.

Detecting communities of users can be of great importance in a social network. For example, understanding the evolution of a community may help in identifying trends and patterns, and in inferring how their properties change over time. Moreover, the identified communities may be used to provide group recommendations.

The massive volume of data associated with a network, such as telecommunication network that consists of millions of nodes with multiple edges per node, can make it difficult to use existing techniques to correctly identify the communities in the network. For example, in a telecommunication network where the relationships between the nodes are temporal in nature and the call graphs have disconnected and overlapping components, existing community discovery algorithms may fail to efficiently identify communities in the network. Moreover, the existing community discovery algorithms may require pre-defined objective functions or prior information about the communities.

### SUMMARY

Some embodiments of the inventive concepts provide systems and/or methods for identifying reasonable communities in networks, such as telecommunication networks, social media, office networks, academia networks, community networks etc. The disclosed methods and systems may consider the dynamics and/or heterogeneity of the group members/users in a network, to provide a more appropriate basis for group recommendations.

Some embodiments of the invention provide methods of identifying user communities in a telecommunication network (100). The methods include extracting (35) fields from communication records (30) that contain data regarding communications of users of the telecommunication network, generating (37) a plurality of nodes (10) based on the extracted fields wherein each of the plurality of nodes corresponds to one of the users of the telecommunication network, determining (44) similarities between pairs of nodes in the plurality of nodes using a similarity metric that measures relationships between the users of the telecommunication network based on the communication records, and grouping (48) the plurality of nodes into non-overlapping communities (20A, 20B) based on the determined similarities.

The methods may further include removing (52) outliers from the communication records before determining similarities between the pairs of nodes.

The methods may further include segregating (54) the communication records based on geo-spatial criteria before determining similarities between the pairs of nodes.

The methods may further include, after grouping the nodes in to non-overlapping communities, analyzing (62) the communities using performance metrics to determine a quality of the formed communities.

Determining similarities between pairs of nodes may include generating a similarity matrix that defines similarities between each pair of nodes in the plurality of nodes.

In some embodiments, determining similarities between a pair of nodes may include generating a distance metric between the pair of nodes, wherein the distance metric between two nodes A and B is defined as

$$f ( \vec{A} , \vec{B} ) = \frac{\vec{A} \cdot \vec{B}}{{\vert \vec{A} \vert}^{2} + {\vert \vec{B} \vert}^{2} - \vec{A} \cdot \vec{B}}$$

where \vec{A} and \vec{B} are vectors having the form

\vec{A}=(A,a₁)\vec{a}₁+(A,a₂)\vec{a}₂+ . . . +(A,aₙ)\vec{a}ₙ and

\vec{B}=(B,b₁)\vec{b}₁+(B,b₂)\vec{b}₂+ . . . +(B,bₘ)\vec{b}ₘ

where {a1, . . . , an} is the set of nodes adjacent to node A, {b₁, bₘ} is the set of nodes adjacent to node B, (A,aₙ) is an edge weight between node A and node aₙ, and (B,bₘ) is an edge weight between node B and node bₘ, where the scalar product \vec{A}·\vec{B} vectors \vec{A} and \vec{B} is given by

\vec{A}·\vec{B}=Σ_{i,j}(A,aᵢ)*(B,bⱼ) if \vec{a}ᵢ=\vec{b}ⱼ and where

|\vec{A}|²=\vec{A}·\vec{A}

The edge weight (A,aₙ) between node A and node an may be related to a number of communications between a user represented by node A and a user represented by node aₙ, a duration of communications between a user represented by node A and a user represented by node aₙ, and/or a bandwidth of communications between a user represented by node A and a user represented by node aₙ.

The communication records may include call detail records that contain data regarding telephone calls of users of the telecommunication network. The fields extracted from the call detail record may include calling party, called party, and call duration.

The communication records may include short message service (SMS) and/or multimedia message service (MMS) records that contain data regarding SMS and/or MMS messages transmitted and/or received over the telecommunication network.

Grouping the plurality of nodes into non-overlapping communities may include (a) defining a group of available nodes from the plurality of nodes, (b) aggregate a subset of the available nodes into a community, and (c) removing the agglomerated subset of nodes from the group of available nodes, wherein steps (b) and (c) are performed repeatedly until no available nodes remain.

Related systems and computer program products are also disclosed.

It is noted that aspects of the inventive concepts described with respect to one embodiment may be incorporated in a different embodiments although not specifically described relative thereto. That is, all embodiments and/or features of any embodiments can be combined in any way and/or combination. These and other objects and/or aspects of the present inventive concepts are explained in detail in the specification set forth below.

Other systems, methods, and/or computer program products will be or become apparent to one with skill in the art upon review of the following drawings and detailed description. It is intended that all such additional systems, methods, and/or computer program products be included within this description, be within the scope of the present inventive concepts, and be protected by the accompanying claims.

### BRIEF DESCRIPTION OF DRAWINGS

The accompanying drawings are included to provide a further understanding of the disclosure and are incorporated in and constitute a part of this application. In the drawings:

FIG. 1 is a network graph of an exemplary network showing nodes, edges and groupings.

FIGS. 2-6 are flowcharts that illustrate operations of systems/methods according to various embodiments of the invention; and

FIG. 7 is a block diagram of a system according to some embodiments of the invention.

### DETAILED DESCRIPTION

Embodiments of the present inventive concepts now will be described more fully hereinafter with reference to the accompanying drawings. The inventive concepts may, however, be embodied in many different forms and should not be construed as limited to the embodiments set forth herein. Rather, these embodiments are provided so that this disclosure will be thorough and complete, and will fully convey the scope of the inventive concepts to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present inventive concepts. As used herein, the term “and/or” includes any and all combinations of one or more of the associated listed items.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments of the present inventive concepts are directed towards methods and systems for identifying communities in a network from among a plurality of users of the network. These methods and systems may detect communities in large networks, such as telecommunication networks, for purposes of generating group recommendations for the users of the network.

Methods according to some embodiments include pre-processing usage data related to the users to generate aggregate data. One or more fields from the usage data are extracted and stored in a database of nodes. According to some embodiments, each node may correspond to one of the network users. Based on the stored data, a similarity metric is applied that may be based on a measure of an inter-entity relationship between the nodes. Further, the nodes may be grouped so as to form two or more communities based on the similarity metric. In some embodiments, there may be no overlapping among the nodes of the communities.

According to further embodiments, performance metrics for the communities may be computed to determine the quality of the discovered communities. According to yet further embodiments, the communities may be further analyzed based on the performance metrics, and service recommendations may be generated based on the analyzed properties of the communities.

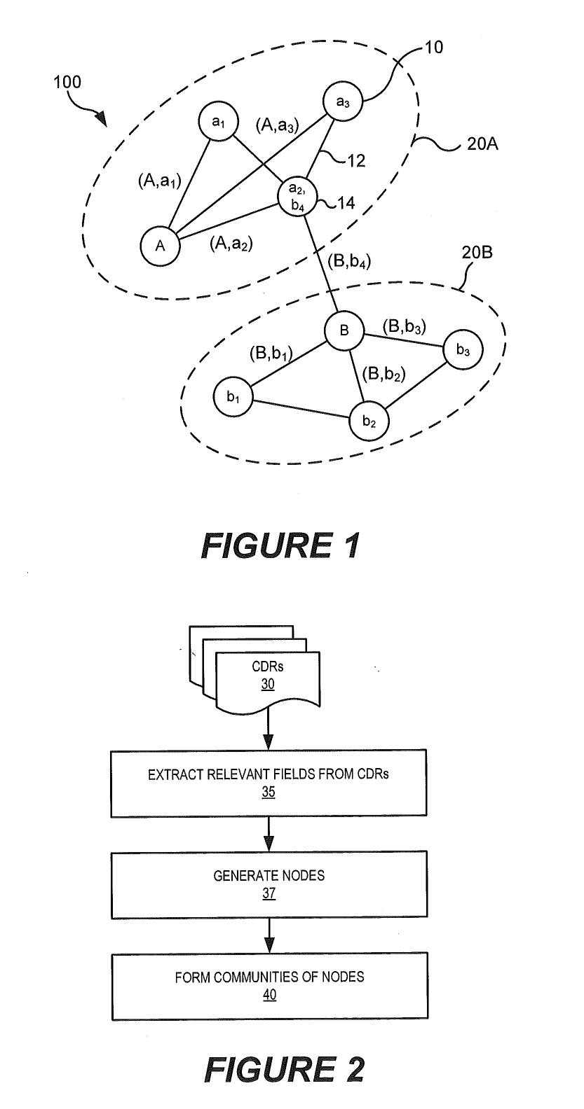

FIG. 1 illustrates a network 100 including a plurality of nodes 10. Each of the nodes 10 may represent a user of the network 100. The nodes 10 include a first node A and a second node B. The nodes 10 further include a plurality of nodes [a₁, a₂, a₃, a₄] that are adjacent to node A, as evidenced by the edge connections (lines) 12 extending between node A and each of the adjacent nodes [a₁, a₂, a₃, a₄]. In this sense, the term “adjacent” means that two nodes are connected directly by a single edge 12 running between the nodes.

The nodes 10 further include a plurality of nodes [b₁, b₂, b₃, b₄] that are adjacent to node B, as evidenced by the edges 12 extending between node B and each of the adjacent nodes [b₁, b₂, b₃, b₄]. In the example illustrated in FIG. 1, node a₂ and node b₄ are the same node 14, because the same node 14 is adjacent to both node A and node B. It will be appreciated that although the network 100 includes eight (8) nodes and ten (10) edges, a typical telecommunications network may include thousands of nodes and millions of edges.

Each of the edges 12 is assigned a weight, represented in FIG. 1 as the pair (N1, N2), where N1 and N2 are the names of the nodes between which the edge 12 runs. Thus, for example, the edge 12 between nodes A and a1 has the weight (A, a₁).

The edge weights may be assigned based on one or more defined criteria that may be static (i.e. unchanging with time), dynamic (i.e., changing with time), and/or a hybrid of static and dynamic. For example, the defined criteria for determining weights may be static for a period of time and may be adjusted at a later time, may be static until the occurrence of a predefined condition, etc.

In a telecommunications network, the defined criteria that is/are used to determine the edge weights may include, for example, a number of communications between the two nodes that define an edge, the type of communications between the two nodes, the average or total duration of communications between the two nodes, the aggregate amount of data communicated between the two nodes, the total or average amount of bandwidth used in communications between the two nodes, or any other desired criteria.

Edge weights may be illustrated graphically in a network graph such as the network graph shown in FIG. 1. For example, edge weights may be inversely proportional to the distance between two nodes. That is, a large edge weight may be indicated graphically by placing two nodes close together in the graph. Edge weights can also be indicated graphically by a thickness of the edge between the nodes. For example, edges with higher edge weights can have greater thicknesses.

Still referring to FIG. 1, the nodes 10 have been divided up into a first community 20A and a second community 20B using a community detection algorithm that may, for example, take into account information such as edge weights, the number of common connections, number and identity of adjacent nodes, or other information when forming the communities. In general, the nodes within the first community 20A may have more commonality with one another than they do with nodes outside the first community 20A. Likewise, the nodes within the second community 20B may have more commonality with one another than they do with nodes outside the second community 20B.

FIG. 2 illustrates a process flow according to some embodiments of the invention, wherein the network is a telecommunication network. As illustrated in FIG. 2, the first step (block 35) is to collect the usage details of the users of the telecommunication network. In this example the usage details may be extracted from Call Detail Records (CDRs) 30 for calls made to/from the network users. A CDR, also known as call data record, is a data record produced by a telephone exchange or other telecommunications equipment documenting the details of a phone call or other telecommunication transaction that is processed by the facility or device. A CDR may include a number of data fields that describe the telecommunication transaction, including the phone number of the calling party, the phone number of the called party, the starting date and/or time of the call, the call duration, the amount billed for the call, total usage time in the billing period, the total free time remaining in the billing period, the running total charged during the billing period, the billing phone number that is charged for the call, the call type (voice, SMS, etc), and other items of data. The CDR may also include SMS data and/or MMS traffic.

Nodes are then defined based on information in the CDRs (block 37).

In block 40, communities of nodes (users) are then defined based on the collected information.

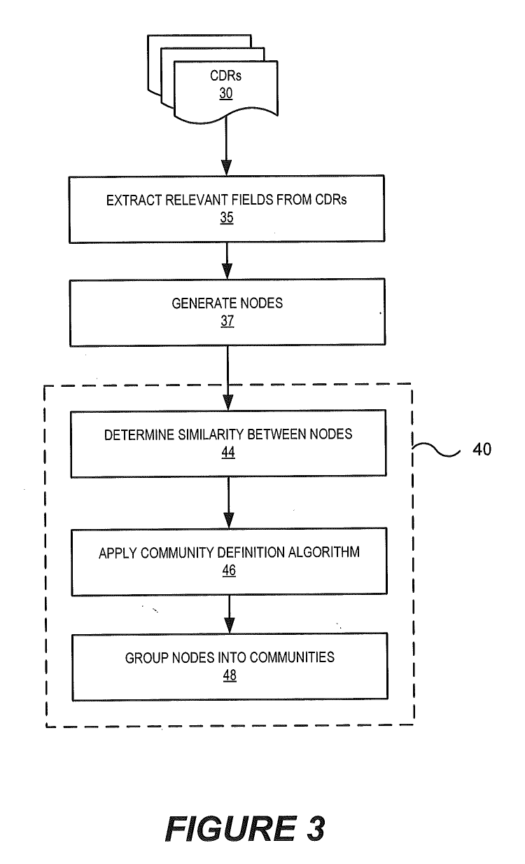

FIG. 3 illustrates operations associated with the definition of communities using the CDRs in more detail. As shown therein, after extracting data from relevant fields of the CDRs (block 35) and defining nodes from the data (block 37), communities of nodes may be defined (block 40) by determining a measure of similarity, or “connectedness” between nodes in response to the extracted fields (block 44), and applying a community definition algorithm to the data (block 46). The formed communities are extracted from the data responsive to the results of the community definition algorithm (block 48).

As noted above, one or more items of data, such as calling party, called party, call duration etc., may be extracted from the CDRs and stored in a database. According to some embodiments of the invention, the database may be an ‘Hbase’ database. HBase is an open source, non-relational, non-SQL distributed database written in Java. Hbase runs on top of the Hadoop Distributed File System (HDFS), and may provide a fault-tolerant way of storing large quantities of sparse data.

Hadoop is a software framework that supports data-intensive distributed applications. It enables applications to work with thousands of computationally independent computers and petabytes of data.

According to some embodiments, the usage data may be extracted from CDRs and stored in an HBase (non-SQL) database. According to further embodiments, location indicators may be used to split up telecom CDRs for distributed processing as discussed in more detail below.

Community Definition Algorithm

Once the data has been stored in the database, two or more communities may be identified from among the users using a community definition or community mining algorithm. According to some embodiments, the community mining algorithm may have two components. The first component applies a similarity metric to find the presence of the nodes in closed ranges. The second component provides a merge function to handle overlapping of the nodes and forming a community in a very fast cycle.

Similarity is a metric that reflects the strength of the relationships between the nodes of the network. The nodes may be grouped based on their similarity. Once the nodes are grouped into communities, the characteristics of each community may be discovered/realized.

Distance Metric

According to some embodiments, a distance metric may be used to determine a level of similarity between pairs of nodes in the network. In some embodiments, the Tanimoto Distance function may be used. The Tanimoto Distance function is often referred to as a proper distance metric. It is given by:

$$f ( \vec{A} , \vec{B} ) = \frac{\vec{A} \cdot \vec{B}}{{\vert \vec{A} \vert}^{2} + {\vert \vec{B} \vert}^{2} - \vec{A} \cdot \vec{B}} \qquad [ 1 ]$$

where

|\vec{A}|²=\vec{A}·\vec{A} [2]

This distance is calculated for each pair of nodes in the network. Consider two nodes A and B where [a₁, a₂, a₃, aₙ] are the adjacent nodes of A and [b₁, b₂, b₃, . . . , bₘ] are the adjacent nodes of B. The nodes A and B may be represented as vectors, as follows:

\vec{A}=(A,a₁)\vec{a}₁+(A,a₂)\vec{a}₂+ . . . +(A,aₙ)\vec{a}ₙ [3]

\vec{B}=(B,b₁)\vec{b}₁+(B,b₂)\vec{b}₂+ . . . +(B,bₘ)\vec{b}ₘ [4]

(A,aᵢ) represents the edge weight between the nodes A and aᵢ and (B,bⱼ) represents the edge weight between the nodes B and bⱼ. The scalar product of the vectors A and B is given by:

\vec{A}·\vec{B}=Σ_{i,j}(A,aᵢ)*(B,bⱼ) if \vec{a}ᵢ=\vec{b}ⱼ [5]

An algorithm for computing the similarity metric is given as follows:

Algorithm 1 - Compute Similarity Metric

```
procedure:computeTanimotoSimilarity( G(V,E) )
    for all u ε V do
        initialize u vector
    end for
    for all u ε V do
        for all v ε V do
            S(u,v) = 0
        end for
    end for
    for all u ε V do
        for all v ε V do
            if( (u != v) && ((u,v) ε E) ) then
                update u vector
            end if
        end for
    end for
    /* TD refers to Tanimoto distance*/
    for all u ε V do
        for all v ε V do
            calculate TD(u,v)
            S(u,v) = S +TD(u,v)
        end for
    end for
end procedure
```

In this metric, the nodes of the network are represented as vectors considering the edge weights of the adjacent pairs of nodes. The Tanimoto distance may be calculated for each pair of nodes in the network, and may be represented as a similarity matrix S of the size (n*n) where n is the number of the nodes in the network.

Merging/Grouping Strategy

According to some embodiments, an agglomerative approach may be used to merge the nodes into communities with the help of the similarity matrix S. The process may be started with a single node, and may continue by aggregating the rest of the nodes into communities. An algorithm for merging nodes to form communities based on the calculated similarity metric is as follows:

Algorithm 2 - Merge Nodes to Form Communities

```
procedure:extractCommunities( G(V,E),S )
    /*Begin with n communities*/
    for all u ε V
        each node defines a C
    end for
    initialize counter = −1
    /*G refers to the grouped nodes set*/
    G = null
    while(G != {V})
        /*C refers to the community set*/
        C[++counter] = null
        do
        (maxI,maxJ) = argMax(S[i][j])
        if( S[maxI][maxJ] > 0 ) then
            C[counter] = C[counter] ∪ {maxI} ∪ {maxJ}
            (maxI,maxJ) = −1
            i = maxJ
            end if
        while( argMax(S[i][j]) > 0 )
        G = G ∪ C[counter]
    end while
end procedure
```

In the foregoing algorithm, the edges are introduced between the pairs of nodes starting with the introduced highest similarity and proceeding to the weakest. In this algorithm, C denotes the community set to which the nodes are merged and G refers to the group nodes set which acts as a reference set. This approach avoids the overlapping of the communities. The algorithm may work much faster compared to traditional algorithms.

Once the communities are identified, specific recommendations may be generated for the identified communities. For example, in terms of a telecommunication network, recommendations may be developed that relate to special plans or non-core offers that may spur the subscribers 10 use their handsets more. The disclosed method may be used to detect pre-eminent groups or communities and target them with niche offers.

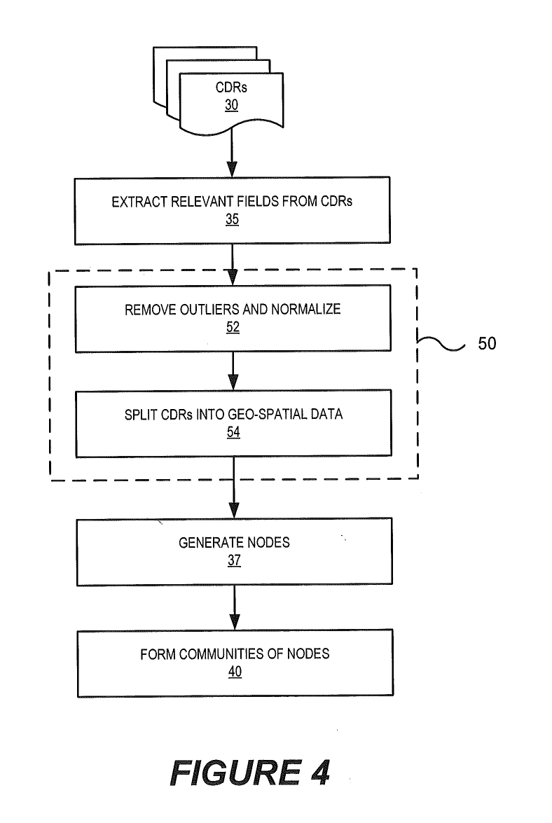

Referring to FIG. 4, in some embodiments, after extracting data from the CDRs (block 35) and defining nodes (block 37), the collected data may be pre-processed (block 50) before the node communities are formed (block 40) so as to extract the relevant information in a specific format.

Since the data that is extracted from a telecommunications network may have a huge size, pre-processing the data before extracting communities from the data may be time-consuming. According to some embodiments, a map reduce programming model employed in a Hadoop architecture may be used to pre-process the data, which may substantially reduce the pre-processing time.

In some embodiments, the pre-processing may include filtering the data to remove outliers and normalizing the data (block 52) and/or splitting the CDRs into geospatial datasets (block 54). Thus, according to some embodiments, pre-processing may be performed to generate a geo-spatial (split) aggregate of data.

An exemplary process of filtering the usage data, removing outliers and normalization is illustrated below.

Filtering the Usage Data

As noted above, in the case of a telecommunication network, the usage details of the user/customer may be captured from Call Detail Records (CDRs). The CDR is a file containing information about recent system usage, such as the identities of sources (calling party), the identities of destinations (called party), the duration of each call, the amount billed for each call, the total usage time in the billing period, the total free time remaining in the billing period, and the running total charged during the billing period, etc. The CDR may also include SMS, data and MMS traffic.

According to some embodiments, a Hadoop based map reduce framework may be employed to pre-process the CDR data by converging them based on geographic location and extracting relevant fields, such as calling party (caller), called party (callee) and call duration details, for graph generation and computation.

Removing Outliers

The CDR data may have objects that do not comply with the general behavior or model of the data. Such data objects, which are grossly different from or inconsistent with the remaining set of the data, are known IIS outliers. According to some embodiments of the invention, the outliers may be removed using following algorithm:

Algorithm 3 - Removing Outliers

```
procedure : removeOutlierMapper( )
    e ← extractor
    d ← input CDR
    S ← input schema
    T ← e.extract(d)
    for(A) ε T do
        if( (A.attributeLength == S.attributeLength) &&
        (A.attributeDataType == S.attributeDataType)) then
            caller ← e.extract(T.caller)
            callee ← e.extract(T.callee)
            duration ← e.extract(T.duration)
            emit(caller, callee, duration)
        end if
    end for
end procedure
procedure : removeOutlierReducer( )
    caller ← callerID
    callee ← calleeID
    duration ← callDuration
    writeToFile(caller, callee, duration)
end procedure
```

Normalization

Normalization may be defined as a process of organizing data for more efficient access. According to some embodiments of the invention, a Minmax normalization technique may be applied for normalizing the edge weight values in a telecommunication network call graph, as it may preserve the relationships among the original data values. According to some embodiments, the normalization may be performed using following algorithm:

Algorithm 4. Normalization of call duration values

```
procedure : findMinMaxDuration(filteredCDR)
    D ← call duration
    minDuration ← 0
    maxDuration ← 0
    while( !scan(filteredCDR).isEmpty )
        if( minD > D) then
            minD ← D
        end if
        if( maxD < D ) then
            maxD ← D
        end if
    end while
    emit(minD, maxD)
end procedure
procedure : normalizationMapper( )
    e ← extractor
    d ← filtered CDR
    T ← e.extract(d.duration)
    minT← min call duration
    maxT← max call duration
    newMaxT← 1
    newMinT ← 0
    newT ← ( (T−minT)/(maxT−minT) )*(newMaxT−
        newMinT)+newMinT
    T ← newT
    emit(e.extract(d.caller), e.extract(d.callee), T)
end procedure
procedure : normalizationReducer( )
    caller ← callerID
    callee ← calleeID
    T ← call duration
    writeToHBase( (caller,callee), T )
end procedure
```

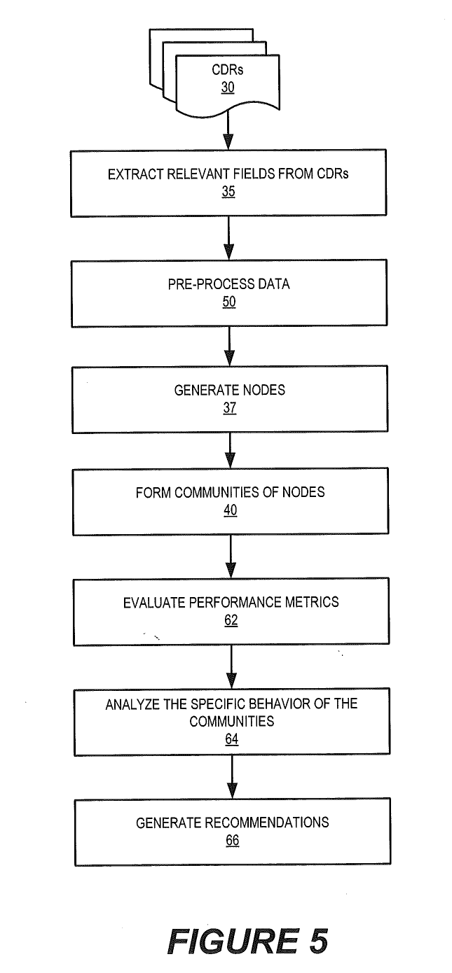

Referring to FIG. 5, after forming the communities of nodes (block 40), some additional embodiments define and evaluate performance metrics to measure the quality of the community mining algorithm used to generate the nodes. In particular, these embodiments define performance metrics (block 62), analyze the specific behavior of the communities (block 64) and generate recommendations in response to the analysis (block 66). These operations are described in more detail below.

Evaluation Metrics

Performance metrics or objective functions are the evaluation measures which determine the quality of the algorithms. These metrics may be used to validate and compare the community mining algorithms. The performance metrics may be broadly classified as (i) internal evaluation metrics and (ii) external evaluation metrics.

Internal Evaluation Metrics

According to some embodiments, the end result may be evaluated based on the data that was used for discovering the communities. These methods usually assign the best score to the algorithm that produces communities with high similarity between the pairs of nodes of the community.

External Evaluation Metrics

According to further embodiments, the end result may be evaluated based on data that was not used for discovering communities. Instead, class labels are used along with external benchmarks to evaluate the community discovery algorithm. The benchmarks may be include pre-classified items which are often created by human experts. Thus, the benchmark sets are considered to provide a “gold standard” for evaluation. These evaluation methods measure how close the communities are to the predetermined benchmark classes.

However, the use of benchmark sets for evaluation may not be adequate for use with real data. Since classes may contain internal structure, the attributes present may not allow separation of the communities, or the classes may contain anomalies. Hence, it may be more desirable to use internal evaluation methods to validate the algorithms used for community detection of a large network, such as a telecommunication network. According to some embodiments of the invention, the quality of the community mining algorithm may be based on evaluation of internal criteria, such as Modularity, Conductance, Internal Density and Volume.

Modularity

Modularity measures the strength of division of a network into the communities. Networks with high modularity have dense connections between the nodes within the community but sparse connections between the nodes in different communities. Modularity can be indicated by the fraction of the connections that fall within the given communities minus the expected such fraction if connections were distributed at random. Modularity may be considered to be positive if the number of connections within the communities exceeds the number expected on the basis of chance. The value of modularity ranges from 0 to 1. A high score of modularity indicates better quality. An advantage of modularity is that it may be computed using only the conductivity of the network, even in the absence of node labels or other information.

The trace of the matrix e,

$$tr ( e ) = {\sum }_{i} {e}_{ii}$$

Modularity is given by,

$$Q = {\sum }_{i} ( {e}_{ii} - {a}_{i}^{2} ) = tr ( e ) - ‖ {e}^{2} ‖ \qquad [ 6 ]$$

where

$${a}_{i} = {\sum }_{j} {e}_{ij}$$

and ∥X∥ represents the sum of the elements of matrix X.

Conductance

Conductance measures how “well-knit” a community is. Conductance may be quantified by analyzing the total number of edges pointing outside the community and the number of connections within the community. The value of conductance ranges from 0 to 1. The higher the score of conductance, the better is the quality of the formed communities. The conductance of a community may be calculated as:

$$f ( c ) = 1 - \frac{{l}_{k}}{2 {m}_{k} + {l}_{k}} \qquad [ 7 ]$$

where lₖ is the number of connections in the boundary of the community k and mₖ is the number of connections in the community.

Internal Density

Internal density refers to the internal edge density of a community, i.e., the number of connections per node in a community. It is determined by analyzing the number of connections and nodes in the community. The value of internal density ranges from 0 to 1. A high score of internal density indicates better quality of the formed community. Internal density of a community may be calculated as:

$$f ( Id ) = 1 - \frac{{m}_{s}}{{n}_{s} * ( {n}_{s} - 1 ) / 2} \qquad [ 8 ]$$

where mₛ is the number of connections in community S, and nₛ is the number of nodes in the community.

Volume

Volume refers to the average of the weights of the edges in the community. The value lies in the range from 0 to I, the higher the value of volume, the better is the quality of the formed communities. The volume of a community may be calculated as:

$$f ( v ) = {\sum }_{( i , j ) ∈ S} {W}_{i , j} \qquad [ 9 ]$$

where the edge (i,j) belongs to the edge set S of the community, W_{i,j} is the weight of the edge (i,j) and n is the number of nodes in the community.

Evaluation Results—Sample Dataset

The method according to an exemplary embodiment of the invention is applied to a sample telecommunication dataset consisting of 65260 nodes and 125537 edges. The results are compared with the known method and are tabulated below. The data generated according to an embodiment of the present invention is listed under the heading ‘Ericom’. High scores of the mentioned performance metrics indicate better quality of the formed communities or groups.

| Algorithm | Random Walk | Bibliometric | Ericom |
|---|---|---|---|
| No. of | 1058 | 1034 | 992 |
| communities | | | |
| Avg. size of | 61.68 | 63.11 | 65.78 |
| communities | | | |
| Modularity | 0.517 | 0.521 | 0.527 |
| score | | | |
| Internal Density | 0.203 | 0.212 | 0.247 |
| Conductance | 0.534 | 0.512 | 0.641 |
| Volume | 0.681 | 0.675 | 0.697 |

A high Modularity score indicates that the formed communities have thick or close-knit connections between the nodes within the community, but meager connections between nodes in different communities. A higher value of Internal Density signifies a higher number of connections per node in a community. This points to the preeminence structure of the formed communities. A higher score of Conductance indicates a relatively lower number of connections at the boundary of the community compared to the number of connections within the community. A higher Volume score denotes that the discovered communities are superior in nature, and thus may possess higher business potential.

The performance scores of the method according to embodiments of the invention appear to be higher than those of existing methods. Moreover the quantity distribution of the discovered communities is comparatively higher than that of present methods. The number of disconnected components is less and overlapping of communities does not occur. The basic structures of the network were efficiently grouped. The above results indicate that the discovered communities are of high quality.

Analyzing the behavior of these communities may result in information of high quality. Based on the behavioral properties of the communities, group recommendations may be generated.

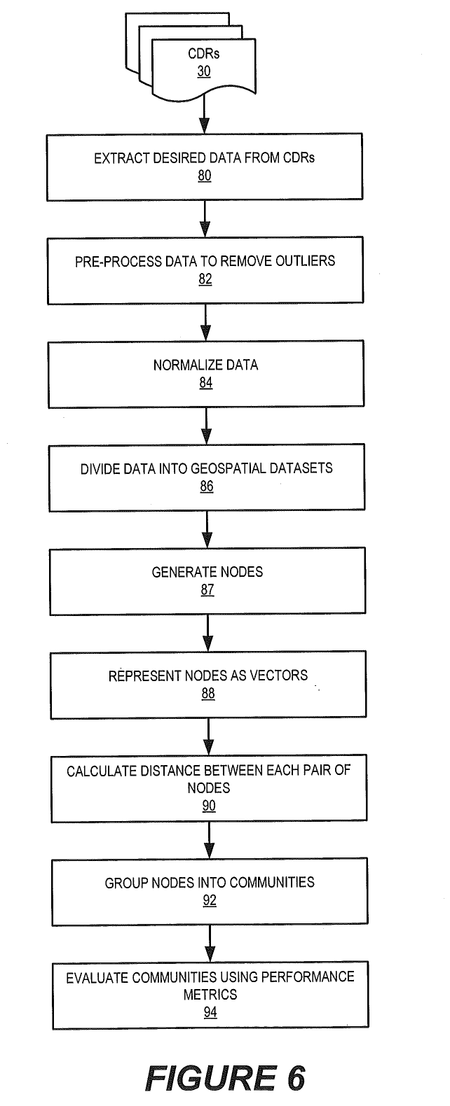

Further embodiments of the invention are illustrated in the flowchart of FIG. 6. As shown therein, operations according to some embodiments may include extracting the CDRs (block 80), removing outliers from the CDRs (block 82), normalizing the data, for example by applying a min-max normalization (block 84), and dividing the CDRs into geo-spatial datasets (block 86). The desired fields (e.g. caller id, callee id and call duration values) are then extracted from the geospatially divided data to define nodes (block 87), and the nodes of the network are then represented as vectors with weights based on values of the desired fields (block 88). A distance, such as a Tanimoto distance, between each pair of nodes in the network is calculated as described above (block 90).

The nodes are then grouped into communities using the merging strategy described above (block 92). Finally, performance metrics are evaluated to determine the quality of the formed communities (block 94).

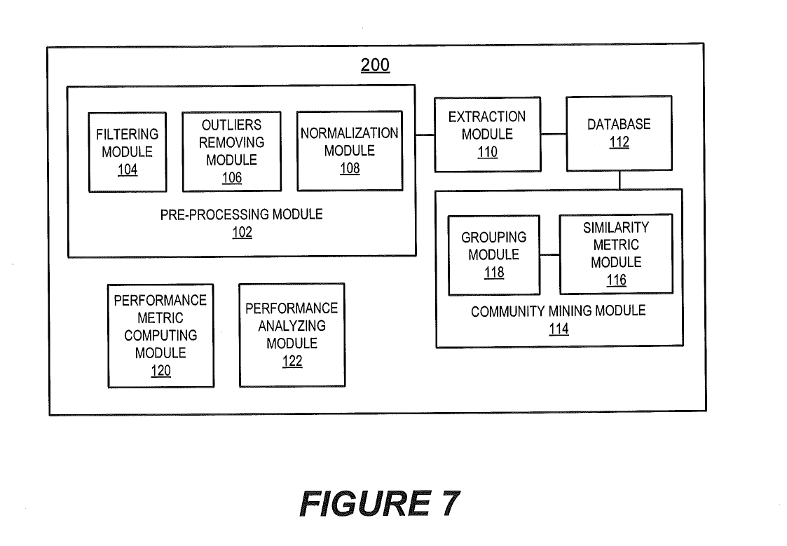

FIG. 7 illustrates a block diagram of a system according to some embodiments of the invention. In particular, FIG. 7 illustrates a computing system 200 for identifying community of users in a network. The system 200 may include a pre-processing module 102 for preprocessing usage data of users of a network and generating aggregated data. According to some embodiments the pre-processing module 102 may include a filtering module 104, an outliers removing module 106 and a normalization module 108.

The system 200 may further include an extraction module 110 for extracting desired fields from the data and storing the extracted fields in a database 112. A community mining module 114 is provided to identify various communities among the stored data.

According to some embodiments, the community mining module 114 may include a similarity metric module 116 that evaluates a similarity metric based on one or more measures of inter-entity relationships between the nodes. The similarity metric may be used to identify nodes within closed ranges. The community mining module 114 further includes a grouping module 118 for grouping nodes based on the processing of the similarity metric module 116 into communities, such that the communities do not have overlapping nodes.

According to further embodiments of the invention, the system 200 may further include a module 120 for computing the performance metrics of the communities to determine the quality of the discovered communities. According to yet further embodiments of the invention, the system 200 may include a module 122 that analyzes the communities based on the performance metrics and generates recommendations based on the analyzed properties of the communities.

Embodiments of the invention may detect meaningful communities within a network, such as a telecommunication network. Some embodiments may efficiently handles disconnected smaller entities of the telecom network. Usage patterns of the formed communities may be analyzed and used to generate special offers and/or plans for members of the community. The disclosed methodology may be employed on distributable, parallel and/or scalable platforms to discover communities in telecommunication call graphs. The said methodology can also be extended to large network, like social networks for extracting non overlapping communities.

As will be appreciated by one of skill in the art, the present inventive concepts may be embodied as a method, data processing system, and/or computer program product. Furthermore, the present inventive concepts may take the form of a computer program product on a tangible computer usable storage medium having computer program code embodied in the medium that can be executed by a computer. Any suitable tangible computer readable medium may be utilized including flash memory, RAM (Random-access memory), ROM (Read-Only memory) EEPROM (Electrically Erasable programmable ROM), hard disk, CD ROM, optical storage devices, magnetic storage devices, DVDs (digital versatile discs) and/or Blu-Ray discs.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations described herein may be written in a programming language such as Java, C, C++, etc. The program code may execute entirely on the user's computer, partly on the user's computer, as a standalone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

In the drawings and specification, there have been disclosed typical embodiments and, although specific terms are employed, they are used in a generic and descriptive sense only and not for purposes of limitation, the scope of the inventive concepts being set forth in the following claims.

What is claimed is:

1. A method of identifying user communities in a telecommunication network, comprising:
extracting fields from communication records that contain data regarding communications of users of the telecommunications network;
generating a plurality of nodes based on the extracted fields, wherein each of the plurality of nodes corresponds to one of the users of the telecommunication network;
determining similarities between pairs of nodes in the plurality of nodes using a similarity metric that measures relationships between the users of the telecommunication network based on the communication records; and
grouping the plurality of nodes into non-overlapping communities based on the determined similarities.

2. The method of claim 1, further comprising:
removing outliers from the communication records before determining similarities between the pairs of nodes.

3. The method of claim 1, further comprising:
segregating the communication records based on geo-spatial criteria before determining similarities between the pairs of nodes.

4. The method of claim 1, further comprising:
after grouping the nodes in to non-overlapping communities, analyzing the communities using performance metrics to determine a quality of the formed communities.

5. The method of claim 1, wherein determining similarities between pairs of nodes comprises generating a similarity matrix that defines similarities between each pair of nodes in the plurality of nodes.

6. The method of claim 1, wherein the determining similarities between a pair of nodes comprises generating a distance metric between the pair of nodes, wherein the distance metric between two nodes A and B is defined as:
$$f ( \vec{A} , \vec{B} ) = \frac{\vec{A} \cdot \vec{B}}{{\vert \vec{A} \vert}^{2} + {\vert \vec{B} \vert}^{2} - \vec{A} \cdot \vec{B}}$$
where \vec{A} and \vec{B} are vectors having the form:
\vec{A}=(A,a₁)\vec{a}₁+(A,a₂)\vec{a}₂+ . . . +(A,aₙ)\vec{a}ₙ and
\vec{B}=(B,b₁)\vec{b}₁+(B,b₂)\vec{b}₂+ . . . +(B,bₘ)\vec{b}ₘ
where {a₁, . . . , aₙ} is the set of nodes adjacent to node A, {b₁, . . . , bₘ} is the set of nodes adjacent to node B, (A,aₙ) is an edge weight between node A and node aₙ, and (B,bₘ) is an edge weight between node B and node bₘ;
where the scalar product \vec{A}·\vec{B} between vectors \vec{A} and \vec{B} is given by:
\vec{A}·\vec{B}=Σ_{t,j}(A,aᵢ)*(B,bⱼ) if \vec{a}ᵢ=\vec{b}ⱼ
and where

|\vec{A}|²=\vec{A}·\vec{A}.

7. The method of claim 6, wherein the edge weight (A,aₙ) between node A and node aₙ is related to a number of communications between a user represented by node A and a user represented by node aₙ.

8. The method of claim 6, wherein the edge weight (A,aₙ) between node A and node aₙ is related to a duration of communications between a user represented by node A and a user represented by node aₙ.

9. The method of claim 6, wherein the edge weight (A,aₙ) between node A and node aₙ is related to a bandwidth of communications between a user represented by node A and a user represented by node aₙ.

10. The method of claim 1, wherein the communication records comprise call detail records that contain data regarding telephone calls of users of the telecommunication network.

11. The method of claim 10, wherein the fields extracted from the call detail record include caller, callee, and call duration.

12. The method of claim 1, wherein the communication records comprise short message service (SMS) and/or multimedia message service (MMS) records that contain data regarding SMS and/or MMS messages transmitted and/or received over the telecommunication network.

13. The method of claim 1, wherein grouping the plurality of nodes into non-overlapping communities comprises:
(a) defining a group of available nodes from the plurality of nodes;
(b) agglomerating a subset of the available nodes into a community; and
(c) removing the agglomerated subset of nodes from the group of available nodes;
wherein steps (b) and (c) are performed repeatedly until no available nodes remain.

14. A system (200) for identifying user communities in a telecommunication network (100), comprising:
an extraction module (110) configured to extract fields from communication records that contain data regarding communications of users of the telecommunication network and to generate a plurality of nodes based on the extracted fields, wherein each of the plurality of nodes corresponds to one of the users of the telecommunication network;
a similarity metric module configured to determine similarities between pairs of nodes in the plurality of nodes using a similarity metric that measures relationships between the users of the telecommunication network based on the communication records; and
a grouping module configured to group the plurality of nodes into non-overlapping communities based on the determined similarities.

15. The system of claim 14, further comprising a pre-processing module configured to remove outliers from the communication records and to segregate the communication records based on geo-spatial criteria.

16. The system of claim 14, wherein the similarity metric module is configured to determine similarities between pairs of nodes by generating a similarity matrix that defines similarities between each pair of nodes in the plurality of nodes.

17. The system of claim 14, wherein the similarity metric module is configured to determine similarities between pairs of nodes by generating a distance metric between the pair of nodes, wherein the distance metric between two nodes A and B is defined as:
$$f ( \vec{A} , \vec{B} ) = \frac{\vec{A} \cdot \vec{B}}{{\vert \vec{A} \vert}^{2} + {\vert \vec{B} \vert}^{2} - \vec{A} \cdot \vec{B}}$$
where \vec{A} and \vec{B} are vectors having the form:
\vec{A}=(A,a₁)\vec{a}₁+(A,a₂)\vec{a}₂+ . . . +(A,aₙ)\vec{a}ₙ and
\vec{B}=(B,b₁)\vec{b}₁+(B,b₂)\vec{b}₂+ . . . +(B,bₘ)\vec{b}ₘ
where {a₁, . . . , aₙ} is the set of nodes adjacent to node A, {b₁, . . . , bₘ} is the set of nodes adjacent to node B, (A,aₙ) is an edge weight between node A and node aₙ, and (B,bₘ) is an edge weight between node B and node bₘ;
where the scalar product \vec{A}·\vec{B} between vectors \vec{A} and \vec{B} is given by:
\vec{A}·\vec{B}=Σ_{i,j}(A,aᵢ)*(B,bⱼ) if \vec{a}ᵢ=\vec{b}ⱼ
and where:

|\vec{A}|²=\vec{A}·\vec{A}.

18. The system of claim 17, wherein the edge weight (A,aₙ) between node A and node aₙ is related to at least one of (a) a number of communications between a user represented by node A and a user represented by node aₙ, (b) a duration of communications between a user represented by node A and a user represented by node aₙ, and (c) a bandwidth of communications between a user represented by node A and a user represented by node aₙ.

19. The system of claim 14, wherein the communication records comprise call detail records that contain caller, callee, and call duration data regarding telephone calls on the telecommunication network.

20. The system of claim 14, wherein the communication records comprise short message service (SMS) and/or multimedia message service (MMS) records that contain data regarding SMS and/or MMS messages transmitted and/or received over the telecommunication network.

21. A computer program product for identifying user communities in a telecommunication network, the computer program product comprising:
a computer readable storage medium having computer readable program code embodied in the medium, the computer readable program code comprising:
computer readable program code configured to extract fields from communication records that contain data regarding communications of users of the telecommunication network;
computer readable program code configured to generate a plurality of nodes based on the extracted fields, wherein each of the plurality of nodes corresponds to one of the users of the telecommunication network;
computer readable program code configured to determine similarities between pairs of nodes in the plurality of nodes using a similarity metric that measures relationships between the users of the telecommunication network based on the communication records; and
computer readable program code configured to group the plurality of nodes into non-overlapping communities based on the determined similarities.
